(19) United States
(12) Patent Application Publication
(10) Pub. No.: US 2026/0028273 A1
(43) Pub. Date: Jan. 29, 2026

(54) SYSTEMS FOR THE PRODUCTION OF CEMENTITIOUS MATERIALS

(71) Applicant: Queens Carbon, Inc., Cedar Grove, NJ (US)

(72) Inventors: Daniel Kopp, Fair Lawn, NJ (US); Nikita Boyko, Bordentown, NJ (US); Bahram Jadidian, Watchung, NJ (US)

(21) Appl. No.: 19/281,174

(22) Filed: Jul. 25, 2025

Related U.S. Application Data
(60) Provisional application No. 63/675,681, filed on Jul. 25, 2024.

(51) Int. Cl. C04B 7/38; C04B 7/44

(52) U.S. Cl. CPC C04B 7/38; C04B 7/44

(57) ABSTRACT

A system for making cementitious material, the system comprising: a raw material preparation subsystem; a raw material processing subsystem; a process atmosphere generation subsystem; and a reaction chamber subsystem. A method for making cementitious material, the method comprising: comminuting an input material; subjecting the input to a vapor-based synthesis; subjecting the input to a reaction atmosphere; producing an exhaust; processing the exhaust; and forming a carbonate product.

### CROSS-REFERENCE TO RELATED APPLICATIONS

This application claims priority to and the benefit of the filing of U.S. Provisional Patent Application No. 63/675,681, entitled “SYSTEMS FOR THE LOW-TEMPERATURE PRODUCTION OF CEMENTITIOUS MATERIALS VIA A HYDROTHERMAL VAPOR RECRYSTALLIZATION”, filed on Jul. 25, 2024, and the specification and claims thereof are incorporated herein by reference.

### BACKGROUND OF THE INVENTION

### Field of the Invention (Technical Field)

The present invention relates to the field of cementitious material production.

### BACKGROUND

Cement is one of the highest volume manufactured products in the world, with an associated carbon footprint of 8% of global CO₂ emissions. Almost all these emissions arise from two elements: decomposition of limestone, responsible for 60% of emitted CO₂ and, fuel combustion, responsible for 40% of emitted CO₂. In legacy processes operating in an open environment, limestone heated to 1500° C. produces CaO and releases CO₂ to the atmosphere as a byproduct. Such a high temperature is achieved through the combustion of fossil fuels, enabling the production of “clinker” that is subsequently ground up to produce the fine powder we call cement.

The cement industry's decarbonization efforts predominantly focus on reducing the amount of clinker used or introducing carbon capture retrofits. Current and past clinker reduction efforts center on the partial replacement of clinker with traditional supplementary cementitious materials (“SCM”) that are mainly sourced from industrial waste such as coal plant-based fly ash and blast-furnace slag. As a result, most industrial cement producers rely on increasing the use of SCM to meet their decarbonization roadmaps. Unfortunately, these efforts face increasing headwinds brought on by a growing supply/demand imbalance, which lead to higher prices, more complex and costly logistics, and concern over long term availability as source industries decarbonize.

Increased use of SCM provides some relief, but not gigaton scale decarbonization, thus motivating segments of the industry to pursue carbon capture utilization and storage (“CCUS”) as the primary means to mitigate CO₂ emissions. While CCUS retrofits offer substantial CO₂ emission reductions at a cement plant, they impose an unacceptable cost premium. The main issue is that CCUS relies on the assumption that a low-cost, abundant, and accessible CO₂ user or CO₂ storage site will exist.

More exotic decarbonization efforts have focused on alternative methods of manufacture that either avoid the use of limestone as the calcium source, or avoid the use of traditional fuels (e.g., oxy-fuel, electrochemical). Non-limestone approaches face industry pushback as they upend the current global cement supply chain. Alternative fuels (e.g., oxyfuel, electrochemical, hydrogen) can enable decarbonization without supply chain disruption. However, similar to carbon capture retrofits, they impose a price premium and/or regulation hurdle, and assume that an off taker will exist. The cement industry is unlikely to adopt any cement innovation that would compromise the revenue stream, lower industry profitability, or require fundamental changes in operating models.

Thus, there is a need for the low-temperature production of cementitious materials via a hydrothermal vapor recrystallization process that does not rely on SCM sources, is cost-effective, and which does not upend supply chains.

### BRIEF SUMMARY OF THE INVENTION

Embodiments of the present invention relate to a system for making cementitious material, the system comprising: a raw material preparation subsystem; a raw material processing subsystem; a process atmosphere generation subsystem; and a reaction chamber subsystem. In another embodiment, the system further comprises a raw material conveyance subsystem. In another embodiment, the system further comprises a processed raw material conveyance subsystem. In another embodiment, the system further comprises a processed raw material infeed subsystem. In another embodiment, the system further comprises a process atmosphere generation subsystem. In another embodiment, the system further comprises a process atmosphere infeed subsystem. In another embodiment, the system further comprises a product outfeed subsystem.

In another embodiment, the system further comprises an exhaust outfeed subsystem. In another embodiment, the system further comprises a product processing subsystem. In another embodiment, the system further comprises an exhaust processing subsystem. In another embodiment, the system further comprises a water management and treatment subsystem. In another embodiment, the system further comprises a heat recovery subsystem. In another embodiment, the system further comprises a control system. In another embodiment, the system further comprises a product carbonation subsystem.

Embodiments of the present invention relate to a method for making cementitious material, the method comprising: comminuting an input material; subjecting the input to a vapor-based synthesis; subjecting the input to a reaction atmosphere; producing an exhaust; processing the exhaust; and forming a carbonate product. In another embodiment, the vapor-based synthesis occurs at a temperature of between about 200° C. to about 1000° C. In another embodiment, the method further comprises calcining the input material. In another embodiment, the vapor-based synthesis occurs at a pressure of about 0.1 atm to about 100 atm. In another embodiment, the vapor-based synthesis comprises converting the input to a carbonate product. In another embodiment, converting is achieved by a catalyst.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are diagrams showing a cementitious material production system, according to an embodiment of the present invention;

FIG. 2 is a diagram a cementitious material production system with atmosphere processing, according to an embodiment of the present invention;

FIG. 3 is a diagram showing material sourcing, transport, and processing for a cementitious material production system, according to an embodiment of the present invention;

FIG. 4 is a diagram showing processed material transport, reactor material infeed, and reactor processing for a cementitious material production system, according to an embodiment of the present invention;

FIG. 5 is a diagram showing process atmosphere generation, process atmosphere infeed, and reactor processing for a cementitious material production system, according to an embodiment of the present invention;

FIG. 6 is a diagram showing vapor-based synthesis methods for a cementitious material production system, according to an embodiment of the present invention;

FIG. 7 is a diagram showing reactor product outfeed and product processing for a cementitious material production system, according to an embodiment of the present invention; and

FIG. 8 is a diagram showing exhaust processing for a cementitious material production system, according to an embodiment of the present invention.

### DETAILED DESCRIPTION OF THE INVENTION

Embodiments of the present invention relate to a system for making cementitious material, the system comprising: a raw material preparation subsystem; a raw material processing subsystem; a process atmosphere generation subsystem; and a reaction chamber subsystem. The system may further comprise a raw material conveyance subsystem. The system may further comprise a processed raw material conveyance subsystem. The system may further comprise a processed raw material infeed subsystem. The system may further comprise a process atmosphere generation subsystem. The system may further comprise a process atmosphere infeed subsystem. The system may further comprise a product outfeed subsystem. The cementitious material may be synthetic and/or natural.

The system may further comprise an exhaust outfeed subsystem. The system may further comprise a product processing subsystem. The system may further comprise an exhaust processing subsystem. The system may further comprise a water management and treatment subsystem. The system may further comprise a heat recovery subsystem. The system may further comprise a control system. The system may further comprise a product carbonation subsystem.

Embodiments of the present invention relate to a method for making cementitious material, the method comprising: comminuting an input material; subjecting the input to a vapor-based synthesis; subjecting the input to a reaction atmosphere; producing an exhaust; processing the exhaust; and forming a carbonate product. The vapor-based synthesis may occur at a temperature of between about 200° C. to about 1000° C. The method may further comprise calcining the input material. The vapor-based synthesis may occur at a pressure of about 0.1 atm to about 100 atm. The vapor-based synthesis may comprise converting the input to a carbonate product. Converting may be achieved by a catalyst (e.g., superheated steam).

Herein are described a system and/or method for the production of cementitious materials using a vapor-based synthesis process. The system and/or method described herein may enable application of vapor-based synthesis for industrial, plant-scale production of cementitious material.

The system and/or method may comprise a vapor-based synthesis (“VS”) process. The VS may drive an elemental diffusion and/or chemical transformation of an input material. The elemental diffusion and/or chemical transformation may be achieved by contacting hydrothermal vapor (e.g., superheated or unsaturated water vapor or water vapor, or any combination) with the input material. The reaction atmosphere may comprise a mixture of gases including, but not limited to, hydrothermal vapor and/or other gases such as carbon dioxide air, nitrogen, or a combination thereof. Any gas may be mixed with the hydrothermal vapor. The VS process may use high-temperature, pressurized steam to drive a chemical reaction between traditional cement feedstocks (e.g., limestone, sand, and/or clay). The chemical reactor may occur at a temperature of at least about 200° C., about 200° C. to about 1000° C., about 300° C. to about 900° C., about 400° C. to about 800° C., about 500° C. to about 700° C., or about 1000° C. The VS process may be up to about 1200° C. cooler than a conventional process. The lower production temperature may enable full or partial electrification and/or use of other energy sources. The total pressure in the reaction vessel may be at least about 0.1 atmospheres (“atm”), about 0.1 atm to 100 atm, about 1 atm to about 97 atm, about 5 atm to about 95 atm, about 10 atm to about 90 atm, about 20 atm to about 80 atm, about 30 atm to about 70 atm, about 40 atm to about 60 atm, or about 100 atm. The chemical reaction of cement feedstock (i.e., input material) may be catalyzed by superheated steam and/or the right atmospheric conditions. The chemical reaction of cement feedstock may produce a desired cementitious material output. Additionally, an exhaust gas may be produced comprising a mixture of the steam and gas released from the material input. The gas may comprise carbon dioxide (CO₂).

The CO₂ may be separated from the steam and then stored, processed, and/or used in other applications. The CO₂ may captured and/or stored. The CO₂ may be contained and packaged as a material output and as such may be processed to form CO₂ of a particular purity level depending on the intended use. The system and/or method may directly use the decomposed/released/generated CO₂ to perform a carbonation process on the converted materials to form a carbonate product. The system and/or method may comprise a subsystem and/or process variation to more efficiently and/or effectively achieve production of cementitious material.

Different variations of the system and/or method may make, use, and/or handle CO₂ in different ways. While capture of CO₂ and its storage and/or use in production may have benefits in some applications, the system and/or method are not limited to such use of CO₂. For example, the CO₂ may be vented as waste rather than stored and/or used.

The system and/or method may be used in the production of cementitious products including, but not limited to, supplementary pozzolanic material (“SPM”), supplementary cementitious materials (“SCM”), hydraulic cement, decarbonized cementitious with pozzolanic materials, or a combination thereof. The system and/or method may be used to create other inorganic materials. The system and/or method may be described using the production of cementitious materials as a general descriptor, but the system and/or method may be more specifically applied to production and/or processing of other material products.

The system and/or method may provide a number of potential benefits. The system and/or method are not limited to always providing such benefits and are presented only as exemplary representations for how the system and/or method may be put to use. The list of benefits is not intended to be exhaustive and other benefits may additionally or alternatively exist.

The system and/or method may enable industrial-scale production of cementitious materials using a VS-based reactor system. The system and/or method describe variations that are capable of industrial-scale production. The system and/or method may be integrated into an existing cement manufacturing process. The system and/or method may enable large-scale production of synthetic cementitious material. The system and/or method may be implemented in a cost-effective manner and may cause the VS process to become a commercially-viable solution compared to other traditional methods. Accordingly, the system and/or method may be implemented through special configuration of existing equipment and/or retrofitting current traditional cement production plants to any number of tons per day.

The system and/or method may aid in reducing CO₂ emissions without compromising cost, performance, or regulatory compliance. CO₂ released from processing raw materials (e.g., release of CO₂ captured in limestone) may be captured in a pure or mostly pure form. Captured CO₂ may prevent the entry of CO₂ directly back into the environment but may also enable the use of the captured CO₂ for other applications.

The system and/or method may enhance energy efficiency of producing cementitious materials. The system and/or method may enable mass production of carbon-neutral synthetic cementitious materials. The system and/or method may be compatible with different forms of energy supply including renewable energy sources because of the lower temperature requirements of the VS process.

The system and/or method may be flexibly adapted for processing a plurality of input material and/or to the production of a plurality of material product outputs.

The system and/or method may maintain a material form factor between an input material and an output material (i.e., a product). An input material in powder and/or pellet form may yield a corresponding powder and/or pellet material output form. Maintaining the material form may avoid traditional changes in material form factor found in most cement production processes where traditionally a powder may be the input and then a “clinker” or a rock-like densified material would be the output. These traditional “clinkers” require additional grinding and milling to convert from a coarse material that may be on the order of inches in size, to a fine material usable for cement, that can be on the order of microns in size.

The system and/or method may comprise a material preprocessing system, a VS processing system, a CO₂ management system, or a combination thereof. The system may be implemented as part of a production plant for cementitious material or other suitable types of materials.

The system and/or method may comprise a material preprocessing system. The material preprocessing system may comprise a sub-system for transport and preparation of material for VS chemical reaction. The material preprocessing system may function to achieve a consistent feedstock of material input to be processed by the VS processing system.

The system and/or method may comprise a VS processing system. The VS processing system may comprise a subsystem configured for material handling and the creation of processing conditions to carry out vapor-synthesis reactions. The subsystem may comprise briquetting, lock hoppers, a desulfurizer, preheaters, reaction vessels, steam generators, condensers, or a combination thereof. The subsystem which may be used to achieve targeted product outputs with desired chemical formulations and physical characteristics.

The system and/or method may comprise a CO₂ management system. The CO₂ management system may facilitate handling and processing of CO₂, in-situ sequestration, storage, re-use of CO₂ within additional chemical processing, other use of CO₂, or a combination thereof.

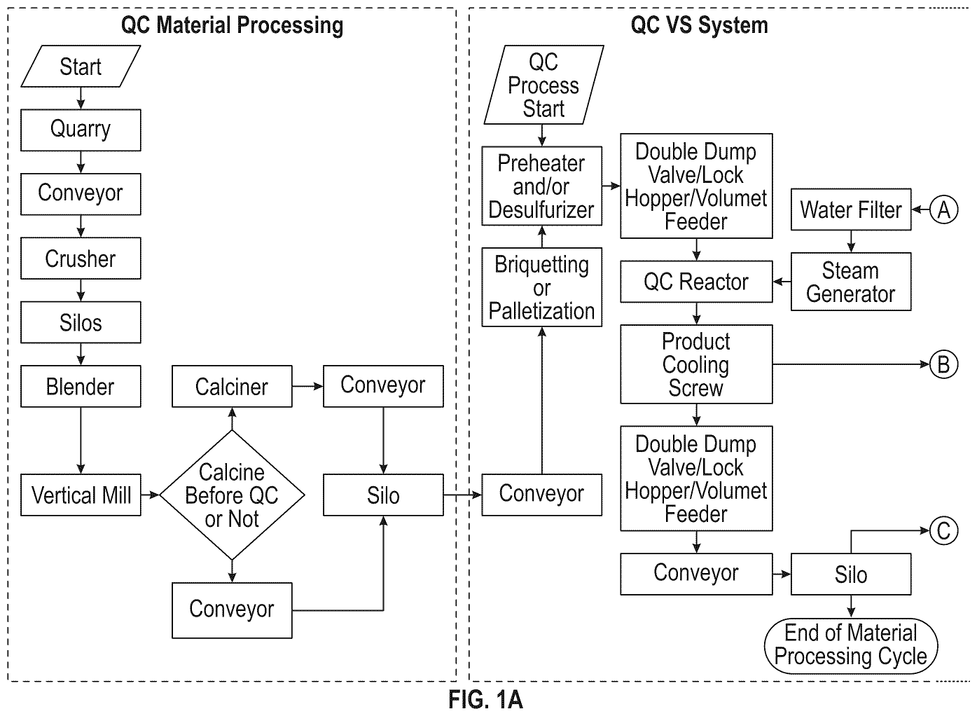

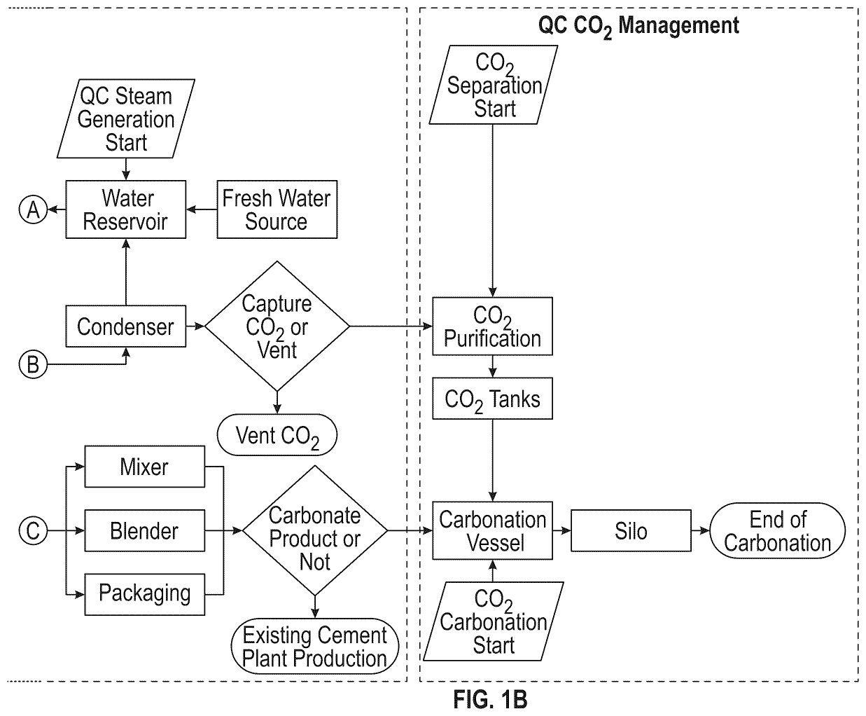

As shown in FIGS. 1A and 1B, the system may comprise a plurality of subsystems that cooperatively enable production of cementitious materials using a VS process.

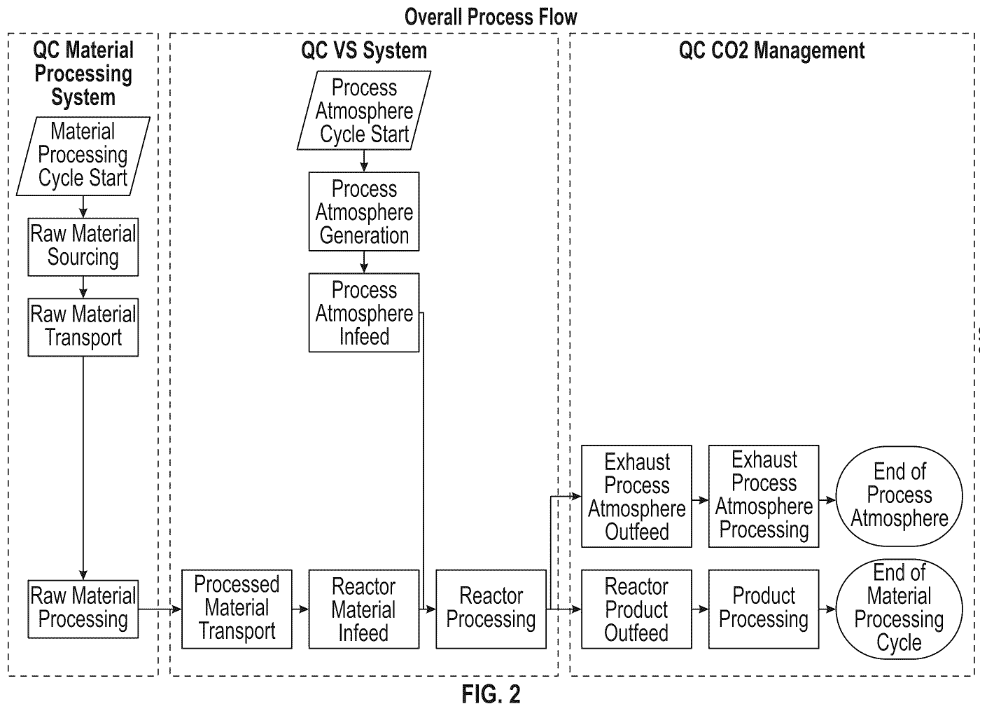

As shown in FIG. 2, the system may be implemented through a configuration of subsystems integrated for specific operation steps for material processing. The subsystems may including, but are not limited to, a raw material preparation subsystem; a raw material conveyance subsystem; a raw material processing subsystem; a processed raw material conveyance subsystem; a processed raw material infeed subsystem; a process atmosphere generation subsystem; a process atmosphere infeed subsystem; a reaction chamber subsystem (i.e., a VS processing subsystem); a product outfeed subsystem; an exhaust outfeed subsystem; a product processing subsystem; an exhaust processing subsystem; a water management and treatment subsystem; a heat recovery subsystem; a control system; a product carbonation subsystem; or a combination thereof.

This system process flow of FIGS. 1A, 1B, and 2 show a method of processing materials for the production of cementitious materials. The system and/or method may not comprise each and every one of these sub-components. The system and/or method may be implemented as a subset of the described systems and/or process. For example, an external system may be used for raw material preparation and/or conveyance.

The material preprocessing system may supply material input ready for processing by the VS processing subsystem. Raw material may be sourced and/or supplied from various sources. They may be prepared or otherwise delivered as a material feedstock that is viable as an input material for the VS processing subsystem.

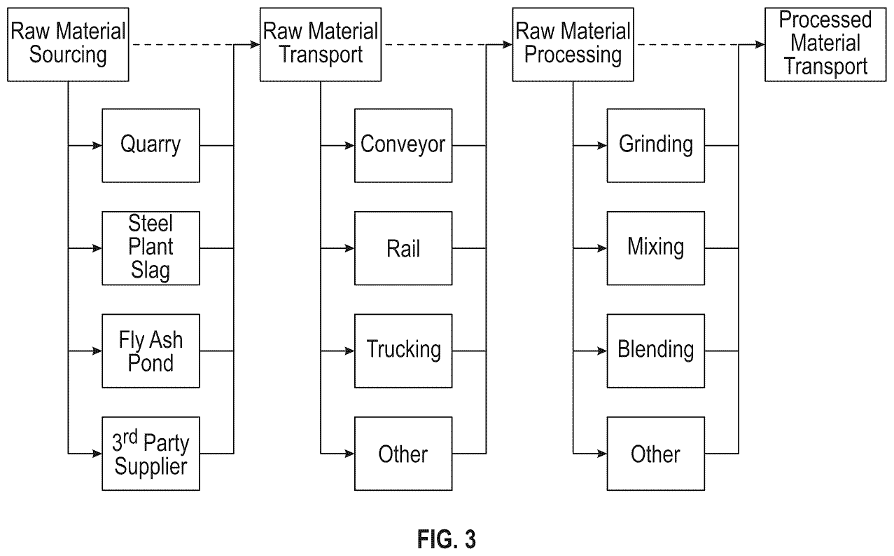

The system and/or method may comprise a raw material preparation subsystem. The raw material preparation subsystem may acquire and/or prepare a raw material (i.e., input material). The raw material may be sourced from a quarry. The raw material may comprise a waste product stream from another industrial process. As shown in FIG. 3, the raw material preparation subsystem may have material sourced from a quarry, steel plant slag, fly ash pond, a third-party supplier, or a combination thereof.

The system and/or method may comprise a raw material conveyance subsystem. The raw material conveyance subsystem may move the material for intake by the processing system. As shown in FIG. 3, conveyance subsystem may include, but is not limited to, a conveyor system; a pneumatic system; a trucking and/or rail system; or a combination thereof.

An existing plant may be retrofitted. The plant infrastructure for material conveyance may be adapted and/or used to supply a material input to the VS processing subsystem.

The raw material processing subsystem may alter the state of the originally-supplied input material. The raw material processing subsystem may comprise a subsystem and/or components for processes relating to comminution, batching, prefeed processing, or a combination thereof. Comminution may include, but is not limited to, ball milling, vertical roller milling, belt roller milling, hammer milling, roller milling, peeling roller milling, wet milling, jet milling, crushing, grinding, and/or a combination, and or any other known milling methods used for comminution, or a combination thereof. Batching may include, but is not limited to, mixing, blending, or a combination thereof. Prefeed processing may include, but is not limited to, monolith formation, granulation, briquetting, pelletizing, or a combination thereof.

The raw material processing subsystem may alter the material from the raw materials. As shown in FIG. 3, raw material processing subsystem may include, but is not limited to, a grinder/crusher system (e.g., a vertical mill), a mixer system, a blender system, or a combination thereof. As shown in FIGS. 1A and 1B, the raw material processing subsystem may comprise a calciner.

The material processing system/subsystem may comprise equipment to form the material input into a desired form factor. Powder may be one raw material input form. Pellets may be another raw material input forms. Other material input forms may be used.

The raw material processing subsystem may adjust a material ratio. The VS process may involve different material ratios depending on the material input and/or the desired material product output. The material input may include, but is not limited to, concrete waste (e.g., calcium aluminum silicate hydrate), fly ash, bottom ash, other mineral feedstock, or a combination thereof. The material input may be preprocessed to have a known calcium-to-silica ratio. The ratio may be achieved during material preprocessing by grinding, batching, separation, other pre-processing procedure, or a combination thereof. The input material may comprise a suitable ratio may may be directly supplied from an external source.

The VS processing subsystem may enable chemical processing of cementitious materials within a scalable industrial production solution.

The VS processing subsystem may subject a material input (e.g., limestone, sand, clay, silica, and/or other materials such as shells, chalk, shale, slate, blast furnace slag, or a combination thereof) to water in the form of steam. The steam may catalyzes a chemical reaction converting the material input to a converted form. In the case of limestone and silica, the mixture is converted to cement. The chemical reaction may depend on properly configured conditions. Temperature and pressure may be managed to induce and/or enhance the chemical reaction. Furthermore, the supply of materials and creating conditions may be managed for proper interactions between the water-based catalyst (e.g., the steam) and the material input.

The raw material input may be desulfurized. The raw material input may be desulfurized before entering the reactor chamber. Desulfurizing the raw material input before entering the reactor chamber may reduce or eliminate the generation and/or release of hydrogen disulfide gas. The raw material input may be desulfurized in a standalone kiln including, but not limited to, a rotary kiln, a tunnel kiln, or a combination thereof. The raw material input may be desulfurized in a preheater and/or calciner. The preheater and/or calciner may operate at a lower temperature than the calcination temperature of the raw material input.

The system and/or method may comprise a processed raw material conveyance subsystem and/or a processed raw material infeed subsystem to manage the supply of input material; a process atmosphere generation subsystem and/or process infeed subsystem to manage atmosphere conditions for the chemical reaction; and a reaction chamber system in which chemical processing of input material occurs.

The processed raw material conveyance subsystem and/or the processed raw material infeed subsystem may feed and/or pre-condition material for delivery to the reaction chamber subsystem (i.e., the VS processing subsystem).

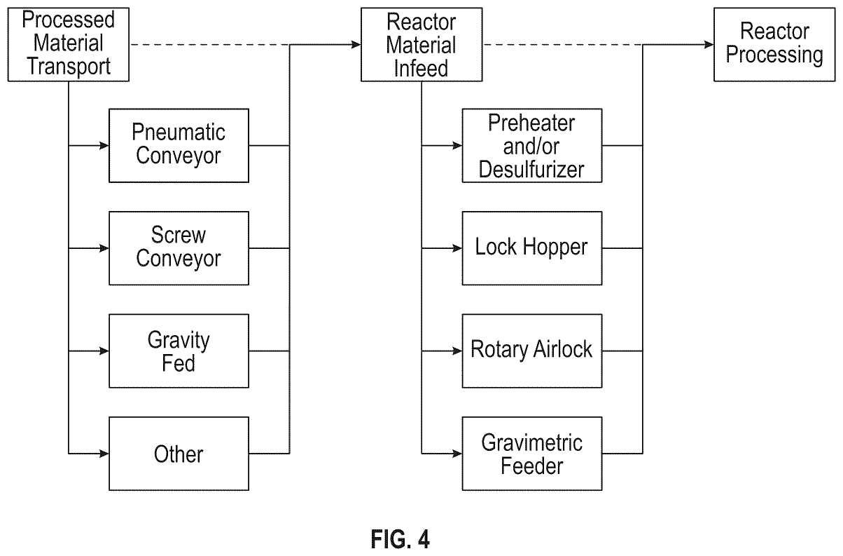

The raw material conveyance subsystem may comprise a component to move material. The processed raw material conveyance subsystem may include, but is not limited to, a pneumatic conveyor, a screw conveyor, a gravity feed system, an elevator feed system, a manual or semi-manual feed system (e.g., bucket loaders, excavators, and/or other earth movers), or a combination thereof, as shown in FIG. 4.

The processed raw material infeed subsystem may feed material into the reaction chamber in a controlled manner so as to enhance efficiency of the chemical reaction (i.e., the VS process). Material may be fed using one or more systems and/or processes depending on desired temperature and/or pressure conditions for the reaction. The processed raw material infeed subsystem may include, but is not limited to, a preheater, a desulfurizer, a lock hopper, rotary airlock, a gravimetric feeder, or a combination thereof, as shown in FIG. 4.

The input material may be preheated. Preheating the input material may be preheated before entering the reactor chamber. Preheating may provide energy savings and/or reduce water use by the system and/or method. Preheating may also allow for the capture of pure and clean CO₂. Preheating may begin a material calcination process and may pre-calcinate an input material. Pre-calcination of the input material may expedite VS process and may results in a more economical process (e.g., save time and money) compared to traditional methods. Preheating may also clean and/or remove extra material or other material components such as organic matter from the input material. Preheating may scrub toxic and/or noxious components. For example, preheating may be used to remove sulfur and/or coal to form an input material. Preheating may be used to prevent or mitigate side reactions of the extra material components within the reactor chamber. Preheating may result in exhaust gas comprising fewer contaminating components compared to traditional methods. Preheating may result in a purer CO₂ output.

The system and/or method may comprise a preheating subsystem. The preheating subsystem may include, but is not limited to, a heat exchanger, rotary dryer, tunnel furnace, flash heater, flash calciner, suspension preheater, pre-calciners, geothermal preheater, waste heat preheaters, other system for preheating, or a combination thereof.

The system and/or method may manage an input material be exposed to elevated temperatures. Accordingly, the system and/or method may comprise a conveyance and/or infeed subsystem. The conveyance and/or infeed subsystem may include, but is not limited to, a lock hopper, gravimetric feeder, volumetric feeder, rotary airlock feeder, double flap dump valve, or a combination thereof. The conveyance and/or infeed subsystem may be configured to handle differential pressure, which may allow an input material to be fed into a pressurized reactor chamber. Components configure to operate at a lower pressure like the double flap dump valve may have rudimentary sealing against pressure. Components such as a rotary airlock may be configured to operate at a higher differential pressure.

The system and/or method may comprise a process atmosphere generation subsystem and/or process atmosphere infeed subsystem. The process atmosphere generation subsystem and the process atmosphere infeed subsystem may produce an atmosphere that acts as a catalyst in the reaction chamber subsystem. The atmosphere may be maintained within targeted range to promote an efficient VS operation. The main VS chemical reaction benefits from targeting a specific atmosphere which may have different temperature and/or pressure conditions depending on the application. The atmosphere may be maintained to ensure VS operation.

Related to management of the atmosphere, the system and/or method may comprise a process gas creation and infeed (“GCI”) subsystem; process gas utilization and control (“GUC”) subsystem; an in-situ gas removal (scrubbing) subsystem; a process gas exhaust treatment and recovery (“GETR”) subsystem; or a combination thereof.

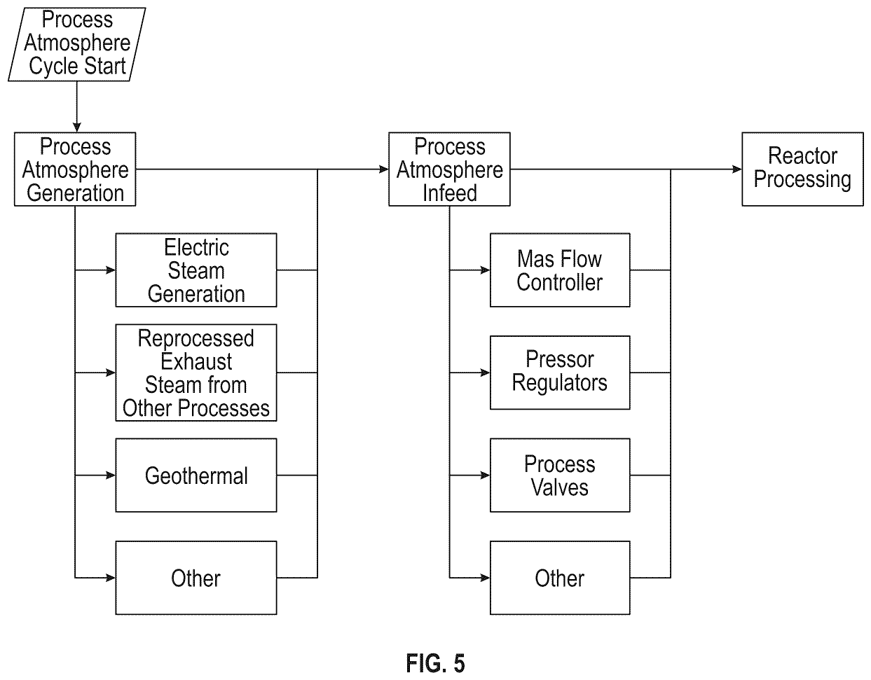

As shown in FIG. 5, the process atmosphere generation subsystem may generates water-based steam. The process atmosphere generation subsystem may generate steam using or interfacing with or more subsystems or sources such as: standard steam generators like electric/green or fossil fuel burning systems; recycled waste steam from power generation equipment; other processes (as shown in FIGS. 1A and 1B where the condenser for extracting CO₂ from exhaust may have condensed water reused for creating steam); natural geothermal steam; or a combination thereof.

The process gas in the reaction may be water-based steam. The steam may be unsaturated, saturated, superheated, supercritical, or a combination thereof. The creation of the atmosphere may use steam generating equipment and/or interface with natural sources of steam. The process gas may comprise mixture of steam and other gases including, but not limited to, nitrogen, oxygen, hydrogen, CO, CO₂, chlorine, nitric oxide compounds (′NOX″), sulfur monoxide compounds (“SOX”), or a combination thereof.

The process gas may be heated to a specific required temperature for the process and precisely fed into the reaction chamber. The additional heating may be achieved by standard steam generating equipment such as superheaters to boost the temperature up to a set point.

The process atmosphere infeed subsystem may feed steam into the reaction chamber. Pressure and/or flow may be controlled either at the entry or exit of the reactor depending on the required flow velocities and atmospheric composition. If constant flow velocity is desired, the flow may be controlled from an entry side. If consistent pressure is desired, the flow may be controlled on an exhaust side. Regulation of the process atmosphere may facilitate safe operation and/or efficient cementitious material production. As shown in FIG. 5, the process atmosphere infeed subsystem may include a mass flow controller, pressure regulators, process valves, and/or other components for feeding the atmosphere (e.g., the steam) to the reaction chamber.

The reaction chamber subsystem may comprise VS process. The reaction chamber subsystem may comprise a reaction vessel in which material input and the process atmosphere is fed. The reaction vessel may generate process atmosphere and/or preheat processed raw materials meet to create conditions for the VS process to occur to convert the input material into a final product.

The reaction chamber may be operated within a temperature range of at least about 200° C., about 200° C. to about 1000° C., about 300° C. to about 900° C., about 400° C. to about 800° C., about 500° C. to about 700° C., or about 1000° C.

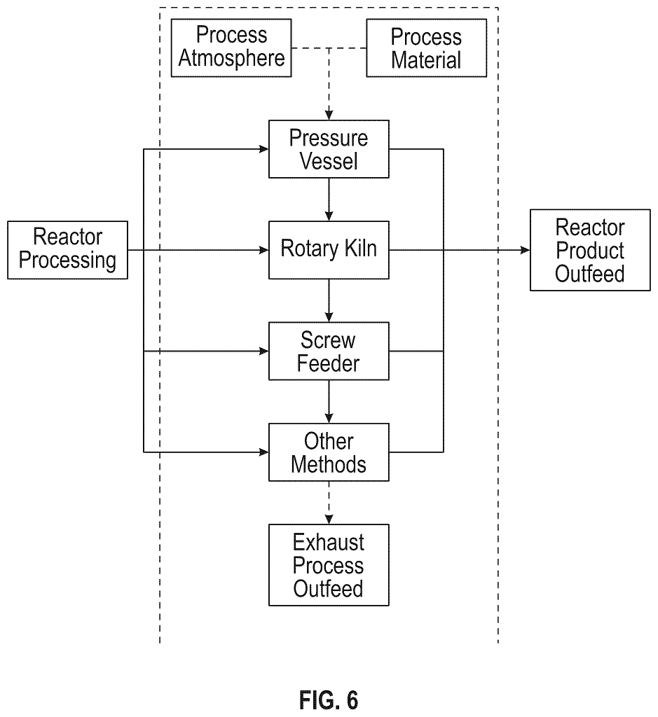

The system and/or method may comprise reaction vessels and/or subprocesses shown in FIG. 6. Components may be used as suitable reaction vessels, based on the desired mode of reaction operation. The design of the reaction chamber may differ depending on targeted temperature range, pressure, and mode of production. Different reactor chambers may be suitable for continuous, semi-continuous, or batch production. A continuous production reaction chamber subsystem may include, but is not limited to, a fluidized bed reactor, rotary kiln, screw processor, thermal screw, mixer, or a combination thereof. A semi-continuous production reaction chamber subsystem may include, but is not limited to, a fixed bed reactor pulsed bed reactor, packed bed reactor, or a combination thereof. A batch production reaction chamber subsystem may include, but is not limited to, a standard pressure vessel, autoclave, hot isostatic pressing (“HIP”) furnace, or a combination thereof.

Different system implementations may target different pressure ratings. For high pressure systems, there may be suitable components that may process and/or handle input material. Bed reactors and pressure vessels are examples of suitable components.

If the pressure in the system and/or method is low (e.g., atmospheric or below atmospheric pressure) other components become viable vessels for the VS reaction to occur in. At atmospheric pressure, open design systems may be used including, but not limited to, an open tunnel kilns, rotary kiln, box furnace, or a combination thereof. The gas control process in those systems may be configured to account for a non-contained environment.

Subsystems of the system and/or method may be controlled to vary the residence time of the material inside the reaction vessel. This can be controlled by the physical properties of the vessel itself such as length; infeed and outfeed methods (feed in less and remove less to maintain longer residence time); by adjusting the process gas and temperature parameter to increase/decrease reaction kinetics; by adding more systems in series to extend the single reactor (similar to length increase for a single piece); or a combination thereof.

Higher throughput may be achieved by parallelizing multiple systems and/or increasing component size.

The system and/or method may employ a process control that may enhance operation. Energetics of the method may depend upon the steam requirement, infeed material temperature, residence time, thermal efficiency of the system, or a combination thereof. The hotter the infeed material, the less additional heat input that may be required from the process gas and any external/internal heating elements. Additional supplemental heating can be achieved using multiple external methods including, but not limited to, a heat jacket, cartridge heater, coil heater, fuel burner (various fuels), microwave heater, induction heater, or a combination thereof.

The heat may also be supplemented using internal methods including, but not limited to, a hotter process gas, heated auger, heated thermal screw using oil or other fluid medium for heat transfer, heat exchanger, induction heater, or a combination thereof.

Thermal efficiency may enhance reduction of energy usage. Insulation of the system may be used to reduce supplemental heat requirements as well as reduce heat loss. Heat recovery of the hot product may occur once the product leaves the reaction vessel. The vessel itself may also be maintained at a known operating temperature that may be reached by components including, but not limited to, a cooling jacket, air cooling system, refractory (internal or external), cement refractory (internal or external), and/or alumina/ceramic fiber insulation.

The refractory may reduce the heat flux across the cross-sectional area of the reactor and the cooling methods can remove any excess heat that leaks through the refractories. This extra heat may be collected and/or used for other purposes such as preheating the raw material.

The system and/or method may comprise a product outfeed subsystem and/or product processing subsystem. The product outfeed subsystem and/or the product processing subsystem may extract and/or receive material from the reaction chamber subsystem and may process an output material.

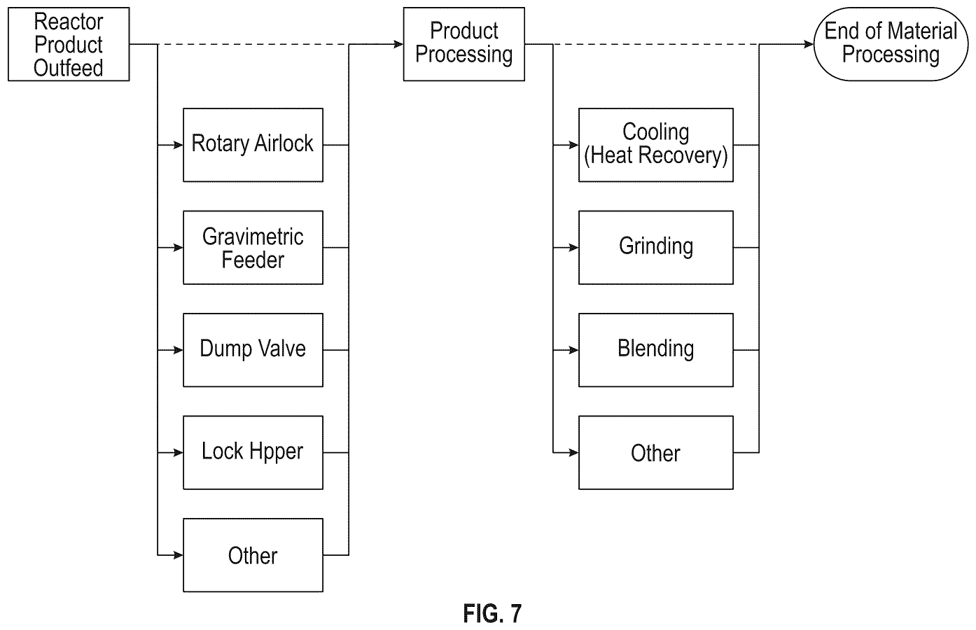

Similar methods and subsystems for processed raw material input may be employed for product outfeed. The same pressure and temperature constraints may apply for the outfeed. There may be more flexibility for equipment sourcing and control on the outfeed side. Integration of a cooling section into reaction vessel designs of the reaction chamber subsystem may reduce the temperature of the product. Controlling the temperature of the product may help in two ways: first, the equipment used for outfeed may be sized and built to much lower temperature requirements thereby often lowering the capital costs, and second, controlling temperature may allow for control over the cooling rate of the final product which is useful for product quality control. As shown in FIG. 7, a product outfeed subsystem may include: lock hoppers, gravimetric feeders, volumetric feeders, rotary airlock feeders, and/or dump valves (e.g., double flap dump valves).

The system and/or method may comprise a product processing subsystem. The product processing subsystem cool and/or adjust material particle size, moisture content, and/or phase composition.

The product processing subsystem may comprise a cooling system. Hot product may be fed directly from the reactor vessel into a cooling vessel. The cooling vessel may be the same as the reaction vessel but instead of additional heat being added, heat may be removed. This can be done using components including, but not limited to, a cooling jacket, cooling grate, blower, or a combination thereof.

Once the product material is at the correct temperature and has been removed from the reaction vessels it may be moved on to other post processing.

Post processing of the material output may ensure the product conforms with specifications and is uniform in quality. The metrics that are examined include, but are not limited to, particle size, moisture content, product phase composition, reaction completion, or a combination thereof.

Particle size and moisture control may be adjusted using components including, but not limited to, a grinder, blender, crusher, mixer, granulator, ball mill, wet mill, vertical roller mill, sprayer, or a combination thereof.

Product phase composition may be controlled using the same components as above. If additives are desired or the chemical composition needs to be modified, all the required ingredients may be added to the various blenders/mixers/grinder to homogenize the final product mix.

The post processed material output may be conveyed or otherwise delivered for consumption and/or packaging.

The system and/or method may comprise an exhaust outfeed subsystem and/or an exhaust processing subsystem. The exhaust outfeed subsystem and/or an exhaust processing subsystem may collect exhaust output and/or process the exhaust. Exhaust gases may be given off by the VS reaction. These gases may be captured and appropriately handled. The exhaust gas may be captured and/or stored. For example, CO₂ may be captured and/or refined as a secondary material product. The exhaust gas may be captured and/or processed for at least partially reuse in other systems and/or processes.

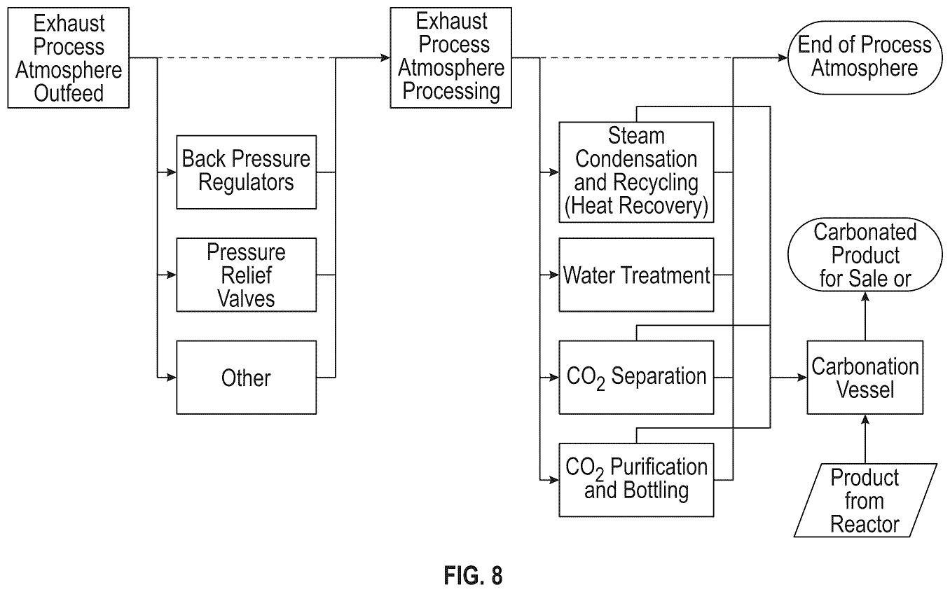

Depending on the control method used for the process gas infeed, the exhaust gases may be controlled. If controlled on the inlet side (flow control), the process gas may automatically make its way to the processing subsystem without restriction. If controlled on the exhaust side (pressure control), the exhaust may be metered using components including but not limited to, a back pressure regulator, relief valve, burst disk (one time safety device), flow restrictor valve, or a combination thereof, as shown in FIG. 8.

The exhaust gas may proceed to a processing step. The exhaust gas may be hot and may comprise a plurality of gases and/or fluids. The hot gas may be cooled and condensed using components such as a condenser and/or chiller. Cooling and/or condensation may separate a gas from any water vapor. Condensed water may be reused and sent back to the beginning of the process and/or converted to steam as shown in FIGS. 1A and 1B. The system and/or method may comprise a water management and/or treatment subsystem which may be redistributed water for reuse. The system and/or method may comprise a subsystem to treat clean and/or condition the water and/or fluid that is reused.

Heat collected during the condensation process may be used to heat fresh water into steam or to preheat any raw material. Heat recovery from this exhaust water and gas may enhance energy efficiency of the system and operation. The system may include a heat recovery subsystem to facilitate reuse of captured heat. Alternatively, the configuration and integration of other subsystems may facilitate thermal management.

The gas may be cleaned or refined using various subsystems and/or processes. Using separator equipment such as vortex separator, the gas may be cleaned of any dust or debris and be collected for further processing. The separated gas may be purified and/or compressed and stored for either future use or for sale as a product.

The CO₂ management system may handle and/or use the exhaust gas from the VS process. The exhaust gas may comprise CO₂, though other gases may additionally and/or alternatively be captured. In cases where a more pure, refined exhaust gas is desired, the exhaust gas may be cleaned and/or refined as described above.

The processed exhaust gas may be compressed and/or stored. This be done to sequester or capture the carbon dioxide. This may alternatively be done for packaging and redistributing as a carbon-dioxide product output. As shown in FIGS. 1A and 1B, CO₂ may be vented and/or not used. The CO₂ may be used in further processing of the material to form a carbonate product.

The CO₂ management system may facilitate carbonation of the material to produce a carbonate product. Carbonation may be referred to as mineralization, recrystallization and/or other terms depending on industry terminology. Recarbonation may be used to produce a carbonate product.

If carbonation is used, such as in the optional process shown in FIGS. 1A and 1B, the exhaust CO₂ gas can be fed into a carbonation vessel. This may be a complimentary subsystem/subprocess to that shown in FIG. 8.

The carbonation vessel may be a vessel similar or even the same as the reaction chamber. The carbonation vessel may be the reaction chamber. Accordingly, the exhaust CO₂ gas may be fed back into a reaction vessel along with the produced cementitious material from prior steps. This is shown as a complementary subprocess in the overall process flow in FIG. 8.

The carbonation vessel may be similar variations to that of the reaction chamber vessel, and may include variations for continuous, semi-continuous, and batch production.

A continuous carbonation vessel subsystem may comprise a fluidized bed reactor, a rotary kiln, a screw processor, a thermal screw, and/or a mixer.

A semi-continuous carbonation vessel subsystem may comprise a fixed bed reactor, a pulsed bed reactor, and/or a packed bed reactor.

A batch carbonation vessel subsystem may comprise a standard pressure vessel, an autoclave, and/or a HIP furnace.

All the same feeding systems and atmosphere control systems as for the reaction chamber subsystem may be used. The difference between the reaction chamber subsystem and the carbonation chamber may be the operating temperature and pressure.

Carbonation temperature may range from at least about 15° C., about 15° C. to about 700° C., about 25° C. to about 650° C., about 50° C. to about 600° C., about 75° C. to about 550° C., about 100° C. to about 500° C., about 125° C. to about 450° C., about 150° C. to about 400° C., about 175° C. to about 350° C., about 200° C. to about 300° C., or about 700° C. Carbonation pressure may range from at least about 1 atm, about 5 atm to about 95 atm, about 10 atm to about 90 atm, about 20 atm to about 80 atm, about 30 atm to about 70 atm, about 40 atm to about 60 atm, or about 100. The partial pressure of CO₂ may range from at least about 1%, about 1% to about 100%, about 5% to about 95%, about 10% to about 90%, about 20% to about 80%, about 30% to about 70%, about 40% to about 60%, or about 100%.

Duplicate components may be employed for the carbonation process. If the temperatures and pressures are low, components with reduced specifications may be employed to reduce operational costs of the system and/or method.

Carbonated material may enter and exit the carbonation chamber using the same feeding methods described above. The feeding method may include, but are not limited to, a lock hopper, gravimetric feeder, volumetric feeder, rotary airlock feeder, double flap dump valve, or a combination thereof. A final carbonated products may be stored in silos for further sale, use, packaging, or a combination thereof.

Embodiments of the present invention provide a technology-based solution that overcomes existing problems with the current state of the art in a technical way to satisfy an existing problem for concrete manufacturers. Embodiments of the present invention achieve important benefits over the current state of the art, such as lower temperature requirements for cement manufacturing. Some of the unconventional steps of embodiments of the present invention include a vapor-based synthesis process.

Note that in the specification and claims, “about” or “approximately” means within twenty percent (20%) of the numerical amount cited. The terms, “a”, “an”, “the”, and “said” mean “one or more” unless context explicitly dictates otherwise. The term “and/or” as used herein means that the listed items are present, or used, individually or in combination. In effect, this term means that “at least one of” or “one or more” of the listed items is present or used.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A system for making cementitious material, the system comprising:
a raw material preparation subsystem;
a raw material processing subsystem;
a process atmosphere generation subsystem; and
a reaction chamber subsystem.

2. The system of claim 1 further comprising a raw material conveyance subsystem.

3. The system of claim 1 further comprising a processed raw material conveyance subsystem.

4. The system of claim 1 further comprising a processed raw material infeed subsystem.

5. The system of claim 1 further comprising a process atmosphere generation subsystem.

6. The system of claim 1 further comprising a process atmosphere infeed subsystem.

7. The system of claim 1 further comprising a product outfeed subsystem.

8. The system of claim 1 further comprising an exhaust outfeed subsystem.

9. The system of claim 1 further comprising a product processing subsystem.

10. The system of claim 1 further comprising an exhaust processing subsystem.

11. The system of claim 1 further comprising a water management and treatment subsystem.

12. The system of claim 1 further comprising a heat recovery subsystem.

13. The system of claim 1 further comprising a control system.

14. The system of claim 1 further comprising a product carbonation subsystem.

15. A method for making cementitious material, the method comprising:
comminuting an input material;
subjecting the input to a vapor-based synthesis;
subjecting the input to a reaction atmosphere;
producing an exhaust;
processing the exhaust; and
forming a carbonate product.

16. The method of claim 15 wherein the vapor-based synthesis occurs at a temperature of between about 200° C. to about 1000° C.

17. The method of claim 15 further comprises calcining the input material.

18. The method of claim 15 wherein the vapor-based synthesis occurs at a pressure of about 0.1 atm to about 100 atm.

19. The method of claim 15 wherein the vapor-based synthesis comprises converting the input to a carbonate product.

20. The method of claim 19 wherein converting is achieved by a catalyst.
